(19) United States
(12) Patent Application Publication
(10) Pub. No.: US 2008/0288578 A1
(43) Pub. Date: Nov. 20, 2008

(54) Method, a Device, and a System for Enabling Data Synchronization Between Multiple Devices

(75) Inventor: Miika Silfverberg, Vantaa (FI)

Correspondence Address: HARRINGTON & SMITH, PC, 4 RESEARCH DRIVE, SHELTON, CT, 06484-6212, US

(73) Assignee: NOKIA CORPORATION, Eepoo (FI)

(21) Appl. No.: 11/547,340

(22) PCT Filed: Apr. 1, 2004
(86) PCT No.: PCT/FI2004/000199

§ 371 Date: Jul. 28, 2008

(51) Int. Cl. G06F 15/16

(52) U.S. Cl. 709/203

(57) ABSTRACT

A method, a device and a system either for user initiated or automatic data synchronization in case of multiple device ownership. Virtual devices (212, 214, 216, 218) corresponding to true physical devices (204, 206, 208, 210) are created and maintained on a server. Virtual devices can be used as data back-up means and as intermediary devices for exchanging data between the physical devices. User-definable identifiers for virtual devices can be shown to the user on the user interface of his terminal for user-friendly manual initiation of data transfer between the physical devices via the virtual device service.

### FIELD OF THE INVENTION

The present invention relates generally to communication systems. In particular the invention concerns multiple terminal devices used by a single entity, e.g. a person, and a method and a corresponding device for enabling flexible data sharing between such terminal devices.

### BACKGROUND OF THE INVENTION

Modern wireless communication systems such as GSM (Global System for mobile communications) and UMTS (Universal Mobile Telecommunications System) are capable of transferring various types of data over the air interface between the network elements such as a base station and a mobile terminal. As the general demand for transfer capacity continuously rises thanks to e.g. new multimedia services coming available, new more efficient techniques have been developed in order to exploit the existing resources to a maximum extent.

A problem still not addressed by the emerging new technologies relates to a scenario in which a single entity, e.g. a person or a company/club, owns a plurality of devices for different reasons and/or uses. For example, some of the devices may be light and small in size like many of the modern mobile terminals tend to be, and thus they fit into pocket nicely while on the move, but the rest of the devices may be large and relatively heavy, like multimedia terminals with bigger screen without forgetting desktop computers, however offering some benefits not available in their smaller counterparts, what comes to e.g. screen resolution and overall usability thereof. Unfortunately contemporary terminal devices do not effectively support data synchronization and sharing in case of a common user/owner having multiple devices. Current devices have been optimised for standalone use.

Publication EP 1102191 discloses a method and an apparatus for reconciling data within a plurality of devices via a central server. With reference to FIG. 1, central server 102 receives information originally entered into a shared database of one remote device 104 and then, upon a proper moment in time, updates the corresponding databases of other related remote devices 106, 108, and 110. Central server 102 comprises a user list and related user-specific database/device lists. One feature provided by the arrangement arises whenever one or more of remote devices 104, 106, 108, 110 to be held in synchronization as to databases of some other remote device 104, 106, 108, 110 is not powered. Central server 102 may, namely, store the updated database information until the power-up of the target remote device and then transfer the data thereto for exploitation.

With several devices in possession, an optimal data location and/or related synchronization method depend on the application. For example, in a calendar application the same data should be directly available in all necessary devices. Thereupon an optimal solution would require either automatic or at least semi-automatic synchronization of the calendar data. In other applications, considering e.g. picture/video viewers or audio players, the amount of associated data may be so huge that automatic data synchronization between multiple devices is neither cost-efficient nor sensible as to transmission capabilities such as maximum reachable data transfer speed and available storage space. Therefore, the user may be willing to explicitly select the data to be synchronized between the devices.

Existing low-range connections like infrared and Bluetooth surely work in some occasions but definitely not in all of them: the users may not consent to carry several devices with them all the time, and thus the required range unavoidably expands too wide soon. Moreover, considering especially modern mobile terminals the user may have several devices but only one SIM card, thus real-time data synchronization by simply sending messages from a device to another is then not possible.

In addition, if the devices the data of which is to be kept in synchronization do not bear fully compatible attributes, e.g. processing, memory, data visualization or audio reproduction means, a straightforward data middle-storaging and forwarding solution is not sufficient as one device, e.g. a mobile terminal, cannot possibly utilize or maybe even receive/store information provided by another device, e.g. a more sophisticated multimedia terminal or a laptop/desktop computer equipped with more cultivated features.

### SUMMARY OF THE INVENTION

The object of the present invention is to alleviate the defects found in prior art solutions by utilizing a concept of a virtual device service offering a number of virtual devices for flexible data synchronization. As to the utility of the invention, data can thus be copied between the actual physical devices via the corresponding virtual devices even if they utilize a common SIM card, are not active/logged into network at the same time, or the distance between them is too big in order to exploit direct low-range transmission techniques like Bluetooth or infrared. Moreover, the devices may not share common properties but data synchronization, however, being still possible due to the data conversion/filtering techniques offered by the virtual device service domain. As one more additional benefit, if a physical device is lost or broken, for example, the corresponding virtual device can work as an automatic data backup or additional storage medium.

Information that is transferred to a virtual device (and from which to another virtual device for delivery to the corresponding another physical device) can be determined either manually, via e.g. the user interface of the physical device on case-by-case (file etc) basis, or automatically including also semi-automatic procedures. Predefined and advantageously user adjustable settings stored in a physical device may indicate that all files or data with a certain type upon change or creation/deletion thereof should always be updated also in one or more other devices belonging to the virtual device domain.

Respectively, information about the target devices to which the information should be finally transferred for synchronization via virtual devices can be stored in the source physical device or in a virtual version thereof. On the other hand, each virtual device may poll both the corresponding physical device, e.g. on a timed manner to retrieve updated data, and the other virtual devices for checking whether some data to be kept in synchronization between them (and thus also between the actual physical devices) has been changed lately. The data transfer from a virtual device to a target physical device may occur in a timed manner, upon receiving a synchronization request from the target device, or straight after the target device has registered in the network/service etc. Naturally the data update/synchronization procedure may be made conditional by first informing the target device about updated data and then waiting for its acceptance for actual update data transfer. Moreover, virtual service may maintain a centralized database of various data objects located in existing virtual devices and of preferred synchronization mappings and linkage in addition to pure decentralized solution in which only the virtual devices either carry such mappings or perhaps just by polling type arrangements update the data between them whenever necessary.

Sketching out a scenario wherein data is transmitted from the target virtual device to the target physical device in a delayed manner (as timed or upon occurrence of some predetermined event), even only a single SIM card can serve the basis for successful data transfer addressing, and, for example, manual copying of phone book information between two mobile terminals, which is a very common but annoying procedure among multiple terminal owners with only a single SIM card, can be omitted as the user may send the phone book or other preferred data to itself via the virtual device service and, before the timer to expire or the predetermined event to occur, change the SIM card from the one terminal to another and wait for the automatic, e.g. push like, or manually initiated update from the virtual device. Thus the two device memories are relatively easily kept in synchronization even with only a single SIM card that is used for virtual-physical device interface addressing as well. Of course, in a more general scenario in which multiple devices are used one at a time with the same SIM card, some other addressing means (like mobile terminal IMEI code, IP address) can be utilized for the virtual device service addressing purposes, and e.g. aforesaid timer based solution is not necessary as the phone book update may occur upon the registration of the target device to network, whereby the target device still utilizes the same SIM card as the source device but different addressing means for virtual device service purposes.

In particular, explicitly (˜manually) initiated data transfer between physical devices can be made easier due to the adoption of the virtual device service concept presented herein. A specific “My Devices” or corresponding menu can be created and tailored in a terminal device to be presented on the U′, e.g. a display, thereof upon activation of such functionality. Different devices may be listed on the display as sorted according to preferred criteria, e.g. a freely user-definable and thus readable/easy-to-understand name given to each physical device having a virtual counterpart on the virtual device domain. Of course, such user-defined name shall be linked to true device-addressing means used by the network at least on the virtual device service side. In many cases fully automated solutions, that are based e.g. data type analysis, are not feasible, considering, for example, transferring of all downloaded multimedia files between devices for synchronization purposes, as if automated such transfer would occupy a lot of transfer capacity of the system and perhaps introduce unwanted costs to the user. Probable as it is that a relatively high percentage of multimedia files downloaded to a device is exploited only once, and thus, the rest of the devices do not need to be updated at all in relation to such files.

In one aspect of the invention a method for managing a virtual device service at a service entity supporting information transfer between a plurality of devices enabled to communicate with the service entity, is characterized in that it has the steps of
receiving information at the service entity from a first device, said information targeted to at least a second device,
storing the information at the service entity in a first location associated with the first device,
storing said information stored in the first location associated with the first device in a second location at the service entity, said second location associated with the second device, and
upon occurrence of a predetermined event transmitting the information in the second location to the second device.

Optionally, said information transmitted to the second device may be made compatible with the capabilities of the second device by exploiting various data pruning/conversion techniques.

In another aspect of the invention a method for transferring information from a first device to at least one other device via a virtual device service is characterized in that it has the steps of
determining at the first device the information to be sent to a second device,
specifying at the first device the second device from a group of one or more devices associated with the virtual device service at said first device, and
transmitting the information to the virtual device service entity to be stored in a first location associated with the first device and further forwarded to the second device via a second location associated with the second device upon occurrence of a predetermined event.

Said specifying of the second device can be executed on the basis of providing the user of the device with a list of the members of said group by e.g. visualizing them on the UI with available identifiers, and then, by user selection specifying the current target device. Alternatively the specifying may be made automatically on the basis of predefined settings for occasions in which a file/data of certain type changes including creation/deletion of such data.

Same methodology applies to determining the information to be sent, i.e. both the manual and automatic techniques can be used.

In a further aspect of the invention, a device operable in a communications network, comprising processing means and memory means for processing instructions and storing data, is characterized in that it is configured to determine the information to be sent to a second device, to specify the second device from a group of one or more devices, and to send the information to a virtual service entity to be stored in a first location associated with the first device and to be further forwarded to the second device via a second location associated with the second device upon occurrence of a predetermined event.

In a further aspect of the invention, a virtual device service entity comprising processing means and memory means for processing instructions and storing data, and data transfer means for transferring data, is characterized in that it is configured to receive information from a first device, said information targeted to at least a second device, to store the information in a first location associated with the first device, to store said information stored in the first location associated with the first device in a second location associated with the second device, and upon occurrence of a predetermined event to transmit the information in the second location to the second device.

Still in a further aspect of the invention, a system comprising a virtual device service entity and at least a first and a second device capable of communicating with said virtual device service entity, is characterized in that
said first device comprises means for sending information to said virtual device service entity,
said virtual device service entity comprises means for receiving the information sent by said first device,
said virtual device service entity comprises means for storing the information in a first location associated with said first device,
said virtual device service entity comprises means for storing the information in a second location associated with said second device to which the information is targeted,
said virtual device service entity comprises means for sending the information to said second device upon occurrence of a predetermined event, and
said second device comprises means for receiving data from said virtual device service.

The concept is further described with reference to FIG. 2, in which a virtual device service 202 is run on a server comprising a plurality of virtual devices 212, 214, 216, and 218. As a general rule, physical devices synchronize against their virtual counterparts and virtual devices synchronize against each other. The virtual device service maintains memory spaces for virtual devices 212, 214, 216, 218 corresponding to the actual physical devices 204, 206, 208, 210 in ownership/control of one entity, e.g. a person, a company or being otherwise connected together (e.g. in joint ownership/control of a plurality of entities). Considering data transmission from a physical device to another, the data is first stored in the virtual counterpart of the sender (˜source) device and then copied to the receiving (˜target) virtual device to be delivered further to the actual receiving physical device when applicable, e.g. upon receiving a notification of the device's registration to the network or in a timed manner.

### BRIEF DESCRIPTION OF THE DRAWINGS

Hereinafter the invention is described in more detail by reference to the attached drawings, wherein

FIG. 1 depicts the cited prior art solution with a central server capable of copying common database information from a device to another,

FIG. 2 illustrates the aforesaid general concept of the invention in which virtual counterparts of physical devices called virtual devices are maintained on a server and used for data storage, converting and forwarding purposes.

FIG. 3 is a flow chart of a method for transferring information according to the invention.

FIG. 4 is a block diagram of a server configured to act as a virtual device service host.

FIG. 5 is a block diagram of a device, e.g. a mobile terminal, acting as an information source and/or a destination for a virtual device server.

FIG. 6 visualizes the virtual device concept in a form of one possible UI (user interface) arrangement on a terminal display.

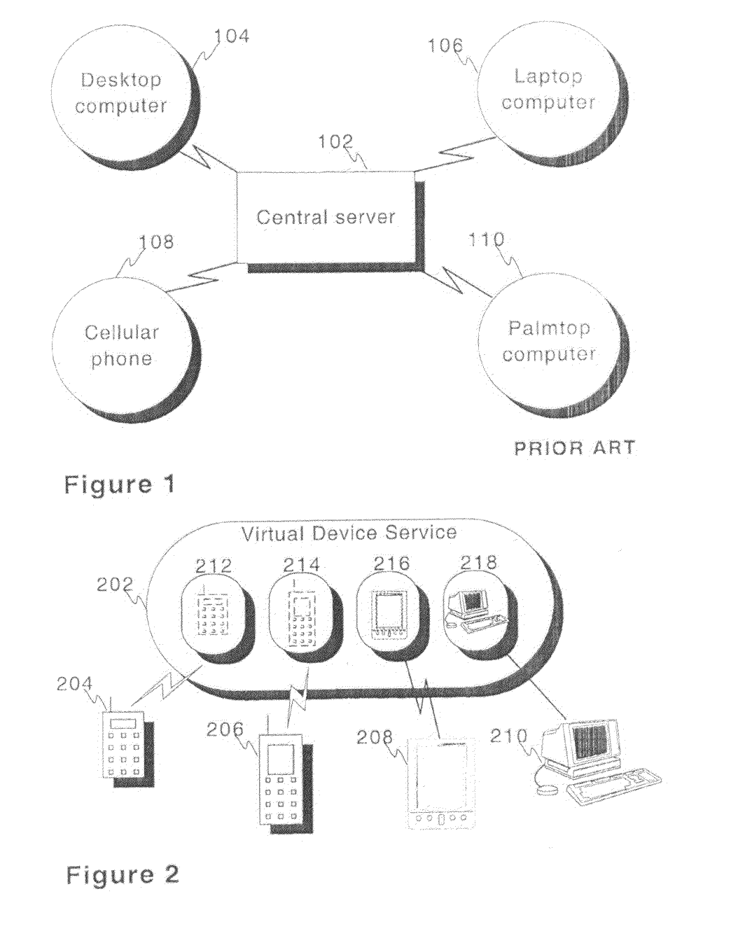

### DETAILED DESCRIPTION OF THE EMBODIMENT OF THE INVENTION

Reverting to FIG. 2, the invention may be utilized in a number of different scenarios. One thing common to all of them is, however, a need for synchronizing data, that is e.g. multimedia files, pictures, audio files, phone book contents, messages, text documents etc whatever data beneficial to forward to device(s) of a virtual domain.

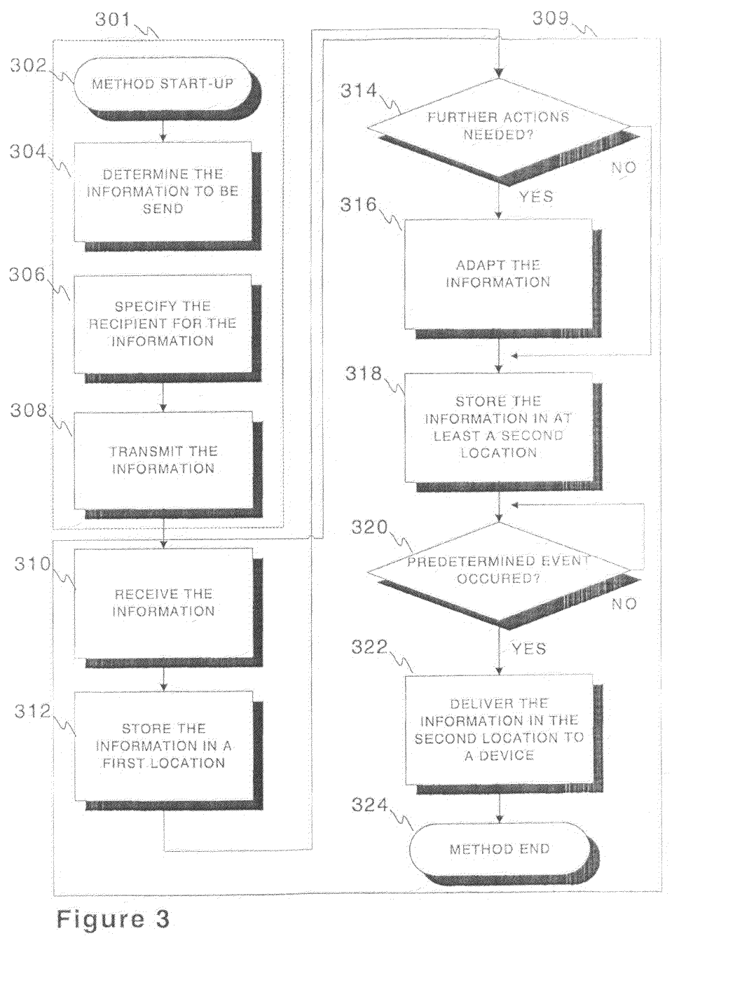

FIG. 3 discloses a flow chart of the method in accordance with the principles of the current invention as described hereinbefore. Dotted lines marked with reference signs 301 and 309 group the method steps represented in the figure initially to terminal side and service side actions respectively. However, as presented below, the service side may also take care of some actions otherwise performed by the terminal and vice versa.

As the virtual device domain contains virtual devices that should, at least partly, be kept synchronized in relation to the changes in data stored in actual physical devices, the virtual device service entity shall create a corresponding virtual domain in which the virtual devices of e.g. certain person or other entity reside. In its simplest form, the domain could just be a list in the memory of the service entity about devices (˜device identifiers) belonging to it. The virtual device domain may be set-up in method start-up phase 302 based on the information provided to the service entity by, for example, a separate virtual device domain set-up request message from a terminal or by directly programming the service entity on the spot, for example. Such message can include separate fields or more complex code words determining a preferred virtual device service configuration, i.e. what devices should be included in a domain and to what extent (data types, data entities etc) they should be kept in synchronization. After creation of a virtual counterpart the terminal may be configured to automatically log in to the virtual device (service) domain e.g. upon registration to the network, and then automatically or as a response to a user request or at least after acceptance by him update data between the virtual and physical devices. Alternatively the terminal may register to the virtual device domain only after initiative taken by the user via the UI of his terminal, for example.

The required mappings/linkage between devices and data thereof may be held in a centralized database, in which case a central entity controlling the domain at the service side can take care of all data exchange between virtual devices and thus the virtual devices just act as physical device related data storages or merely deal with the data transfer from/to the physical counterparts. Alternatively, the virtual devices may perform all the data exchange within virtual device service and utilize the centralized database for acquiring mapping information. In a third solution model mapping information is truly scattered in the virtual devices that act independently or in control of a central entity.

For example, a table may include device identifiers followed by each data element/type stored in a virtual device with optional mappings to data elements/types in other virtual devices. The mappings including direct links between already compatible elements and more complex links requiring e.g. data conversion/adaptation stage may be user-defined and dynamically deliverable/alterable with a settings message, for example, or they can be produced automatically meaning the corresponding data elements in different devices have a common or “standard” meaning, and thus a mapping/link between them may be established without further guidance by the user. Naturally also data elements that are not “pre-mapped” between virtual devices shall be possible to be exchanged, and therefore, virtual devices should include free memory-space (or an option to dynamically reserve more memory) for data elements without direct pre-defined counterpart in the target virtual device. Such data elements without mappings are probable due to explicit data exchange, i.e. the user has manually sent a data element and specified a certain target device belonging to the virtual domain so that the data can be properly forwarded in the virtual domain without any predefined mapping information.

Moreover, during set-up and preferably also dynamically later, the user may be provided with the possibility to generate groupings that are more generic than direct data element mappings between virtual devices and thus faster/easier to create/delete. One group may be established for e.g. work related terminals and another for devices intended for private use. Group definitions shall be stored at least in the service side as to the automated data exchange, and in both the physical terminal and service side as to explicit data transfer. Groups may be defined or handled solely in a physical terminal device side only if the device upon sending such group targeted data converts the target address identifier (which can be a group identifier) to corresponding independent device identifiers. Identifiers to be used for device addressing within the virtual service can be based on e.g. SIM information, IMEI (International Mobile station Equipment Identity) code, specific user name/password combinations given upon device registration to the service etc whatever addressing means seen suitable for the purpose.

In step 304 the information to be sent is determined either automatically by the sending device on the basis of predefined criteria, in which case an optional authorization may be asked from the user even on single data element basis, or manually by the user feedback (through selection or by typing in) via e.g. a service related menu shown on the UI of the device. In another, more virtual device service entity driven, option the service entity polls the devices belonging to the same virtual device domain e.g. in a periodical manner to check if a data element to be synchronized according to the mappings/linkage has changed in order to then retrieve and forward such data.

Step 306 includes specifying the recipient(s) for the information. Respectively in this stage, the performed actions may be automatic and be based on the available existing mappings/linkage information between data elements/types stored in the terminal device/service entity, or manual through user feedback, i.e. the user selects the receiving device(s) from a group of devices associated with the virtual device service. If the specifying is executed at the service entity, step 306 may be executed actually following data transfer step 308. It should be noted that especially in case of explicit, manually initiated data transfer also steps 306 and 304 might be executed in reversed order without any difficulty.

In step 308 the determined information is sent towards the virtual device service by the source device. Information transfer may be wire based or wireless depending on the way the source device is connected to the service. For example, mobile terminals are likely to be connected to services through a wireless connection whereas a desktop computer is fixedly connected to the network via e.g. a standard twisted pair network cable.

In step 310 the virtual device service entity receives the information either directly from the source device or via a number of intermediary devices, and in step 312 stores it in a first location associated with the source device, e.g. to an identifier thereof, sending the data. Such location can be seen to form a part of a virtual device corresponding to the actual physical device as to the data stored in the devices.

In step 314, which is in principle optional, the virtual device service entity checks whether the information should be altered somehow to better fit the capability of target devices that have been defined in step 306. If that's the case, different data adaptation methods including image/text/sound conversions can be performed 316 before placing the data in the target virtual device(s) to be forwarded to the target physical devices. Such adaptation measures may include also e.g. complete deletion of certain data (or substitution with alternative data, e.g. a picture replaced with text “[picture removed]”) if the target device does not support receiving data of that nature. In case of a plurality of target virtual devices such adaptation methods may differ depending on the target device and thus, the same source data may be delivered to many target devices in a different form to each of them.

In step 318 the possibly adapted data is stored in at least one another location, the location(s) in practise corresponding to the target virtual device(s). The data also remains in the first location unless the user has through configuring set the system to only transfer the data and not to act as data storage. In that case after transferring the data to the at least one another location the data may be deleted. Steps 316 and 318 may be executed in reversed order, i.e. adaptation happens at the target virtual device not until the target virtual device has noticed e.g. through data type analysis that the corresponding physical device does not support the data without adaptation.

Step 320 refers to monitoring/waiting for a predetermined event to occur that shall then launch the transmission of the data to the target physical device from the target virtual device thereof. Such events may be either fixed on determined dynamically at the service entity or by the terminal having a virtual counterpart. The physical device may inform the service entity about new event settings with a dedicated message or by embedding the settings information to some other message as a parameter, for example. The event may be a registration to the network or to the virtual device service, said registration recognized by the service. Likewise the event can be an expiration of a timer (note that any timed data update procedure can be seen as that), reception of an explicit update request or data query from the physical device etc. It's clear that such events can be independently determined for each virtual device or alternatively, to a certain group of virtual devices.

Finally the data is delivered to the target physical device(s) in step 322. The service entity may then delete the data stored in the virtual domain if the service was merely used for transferring data or leave it to reside in the virtual device as well if also e.g. data back-up services are needed for. The method execution is ended in step 324.

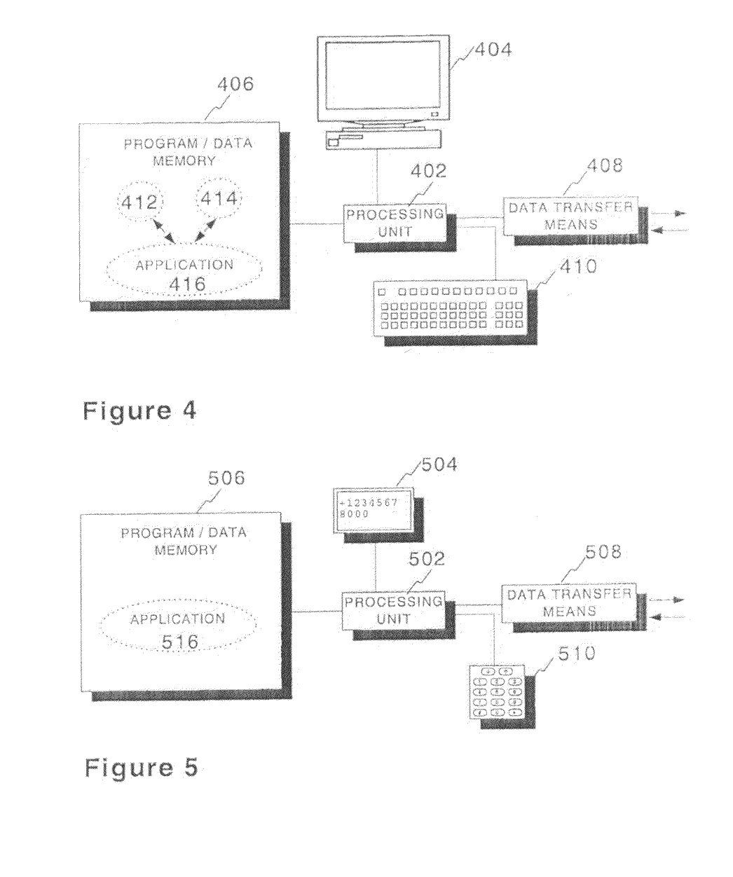

FIG. 4 discloses a block diagram of basic components for a virtual device service entity such as a server capable of executing the method of managing a virtual device service as presented hereinbefore. The entity may thus process, store, and transfer data in accordance with the invention by utilizing the presented components. Memory 406, realized in practise as one or more physical memory chips, comprises necessary code 416, e.g. in a form of a computer program/application, to control the overall data storing and exchange in the virtual device service, and data stored in virtual devices 412, 414. Moreover, memory 406 includes existing data element mappings and Linkage between a number of virtual devices in addition to necessary set-up/configuration information for launching and maintaining the service. Processing unit 402 is required for the execution of method in accordance with instructions 416 stored in memory 402. Display 404 and keyboard 410 are in principle optional but typically needed for providing necessary device control and data visualization means (˜user interface) to the management of the service entity. Data transfer means 408, e.g. a network adapter or a radio transceiver, are required for handling data exchange, for example, acquiring and forwarding data & instructions from/to other devices. Code 416 for the execution of the proposed method can be stored and delivered on a carrier medium like a floppy, a CD or a memory card.

Respectively, a block diagram of user equipment such as a mobile terminal, a PDA, or a desktop/laptop computer capable of utilizing the virtual device service is depicted in FIG. 5. Processing unit 502 controls the execution of actions in accordance with instructions 516 e.g. in a form of an application stored in memory 506. Data transfer means 508 may refer to a transceiver or network adapter, for example. Keypad or other data input means 510 and display 504 are useful for managing, gathering, and visualizing information and actions of the device.

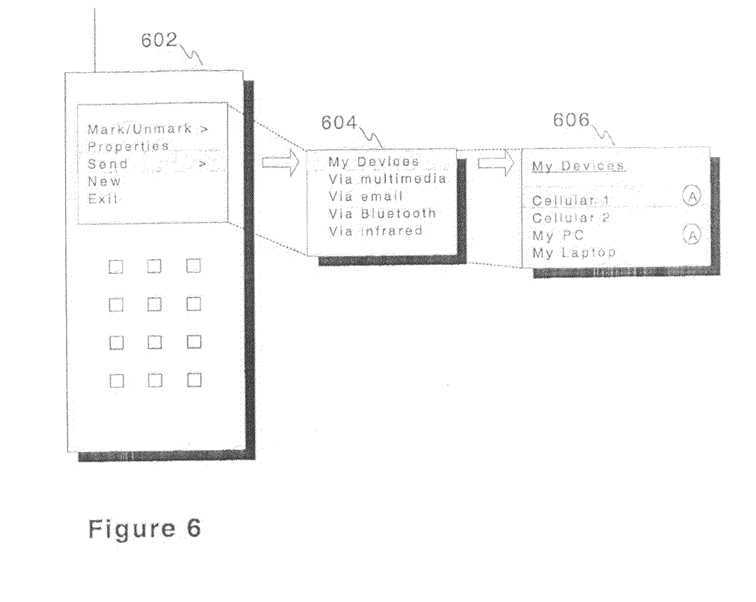

FIG. 6 discloses an option for visualizing a virtual device domain on a terminal display for easy and rapid appliance. The virtual devices corresponding to their physical counterparts are shown in a specific “My Devices” menu, e.g. one device on a row basis. In case of explicit data transfer, i.e. the user manually selects both the data to be transferred and/or the another device to which the data is targeted, the menu structure as visualized to him may comprise first menu 602 from which a data element related action is selected (“send”), a subsequent menu for determining the type of transfer 604 (in this case “My Devices” referring to the virtual device transfer), and the final menu listing the devices included in the same virtual device domain with the device in use 606. In addition to mere device identifier listings, final menu 606 may pass also other supplementary information to the user, e.g. the current status, e.g. registered/not-registered, of the remote device either reported by the service entity or gained through polling it periodically, for example. Status and other information such as “last active” time data may be illustrated via text or symbols like circled A (˜Active) shown on the same line with the device identifier. Moreover, “My Devices” menu 606 may display either all devices in the domain, all devices except the one that is used for accessing the menu at that moment, or just a portion of all devices based on some preferred and selectable/definable criteria (all registered devices, all devices in a certain group etc). If only one device is present in the list, displaying the menu may be completely omitted as the user can be expected to be already familiar with that device's identity, and selection of “My Devices” menu 604 unambiguously defines the preferred target device. Alternatively, identity of the only device may be indicated in menu 604 either in addition to or in place of “My Devices” type transfer. After the target device or a plurality of devices are selected, the selected data element is sent to the virtual device service to be forwarded to the target physical device via its virtual counterpart according to the principles of the invention.

Correspondingly, a similar type of virtual device visualization and selection means can be applied to various different purposes than just explicit data transfer without difficulty. Such purposes include e.g. device status inquiries and device grouping, i.e. whatever purpose with a device selection aspect.

The protocols and protocol stacks utilized in information transfer according to the invention can be selected from the existing ones as the transfer capabilities required for implementing the invention are not particularly complex or special as such, which can be seen as one benefit of the invention. The information exchange between the virtual devices and other entities like the physical devices, which can also be deemed as proxies, may be implemented using a data sharing technology e.g. SyncML data synchronization protocol, or even traditional FTP (File Transfer Protocol).

It should be obvious to a one skilled in the art that different modifications can be made to the present invention disclosed herein without diverging from the scope of the invention defined by the claims. For example, utilized devices and methods steps may vary still converging to the basic idea of the invention. As one observation, from the physical (terminal) device's standpoint the virtual device service can be implemented as an aggregate entity the internal functions and components of which are not visible. Thus, on the virtual domain the existence of an virtual device corresponding to some physical target device is essential, and how the data is delivered thereto, i.e. happens it through the described virtual source device or some other entity, is not always necessary to fix to any certain solution although data transmittal through the virtual source device associated with the physical device transmitting the data is somewhat advantageous as the virtual device serves as a data back-up device at the same time.

1. A method for managing a virtual device service at a service entity supporting information transfer between a plurality of devices enabled to communicate with the service entity, characterized in that it has the steps of
receiving information at the service entity from a first device, said information targeted to at least a second device (310),
storing the information at the service entity in a first location associated with the first device (312),
storing said information stored in the first location associated with the first device in a second location at the service entity, said second location associated with the second device (318), and
upon occurrence of a predetermined event transmitting the information in the second location to the second device (320, 322).

2. The method of claim 1, wherein the information to be transmitted to the second device is adapted to the capabilities of the second device prior to said transmitting (316).

3. The method of claim 2, wherein said adapting includes at least one of the following: conversion of data from a form to another, deletion of data, replacement of data with an indication thereof.

4. The method of claim 1, wherein the received information includes explicit identification information of the targeted second device.

5. The method of claim 1, wherein said receiving information occurs as a response to polling of said first device initiated by the service entity.

6. The method of claim 1, wherein said predetermined event is at least one of the following: expiration of a timer, receipt of a synchronization request, registration to the service by the second device, and registration to the network by the second device.

7. The method of claim 1, wherein said transmitting is performed conditionally by first noticing the second device about forthcoming information transmission and executing the transmission not until the second device has authorized it.

8. The method of claim 1, wherein said information stored in the first location is stored in the second location due to polling of a first virtual device, said first virtual device associated with the first location, performed by a second virtual device associated with the second location.

9. The method of claim 1, wherein said service entity polls the first device for ncw or amended information (304).

10. The method of claim 1, wherein upon storing the information in the second location it is deleted from the first location.

11. The method of claim 1, wherein upon transmitting the information to the second device it is deleted from the second location.

12. The method of claim 1, wherein said second location is determined on the basis of available linkage information associated with said first device (306).

13. The method of claim 12, wherein said first device or said service entity determines said second location.

14. A method for transferring information from a first device to at least one other device via a virtual device service characterized in that it has the steps of
determining at the first device the information to be sent to a second device (304),
specifying at the first device the second device from a group of one or more devices associated with the virtual device service at said first device (306), and
transmitting the information to the virtual device service entity to be stored in a first location associated with the first device and further forwarded to the second device via a second location associated with the second device upon occurrence of a predetermined event (308).

15. The method of claim 14, wherein the information is determined automatically on the basis of predefined criteria.

16. The method of claim 14, wherein the second device is specified automatically on the basis of available data linkage information.

17. The method of claim 14, wherein a list including one or more identifiers of one or more devices associated with the virtual device service is visualized on a user interface of the first device for said specifying.

18. The method of claim 17, wherein the list includes the first device itself.

19. The method of claim 17, wherein the list includes supplementary information related to one or more other devices in addition to said one or more identifiers.

20. The method of claim 19, wherein such supplementary information includes registration status or last active information.

21. A device operable (508) in a communications network, comprising processing means (502) and memory means (506) for processing instructions and storing data, characterized in that it is configured to determine the information to be sent to a second device, to specify the second device from a group of one or more devices, and to send the information to a virtual service entity to be stored in a first location associated with the first device and to be further forwarded to the second device via a second location associated with the second device upon occurrence of at predetermined event.

22. The device of claim 21, further configured to determine the information to be sent automatically on the basis of predefined criteria.

23. The device of claim 21, further comprising means (510) for gathering user feedback, said device configured to determine the information to be sent on the basis of user feedback.

24. The device of claim 21, further comprising a user interface (504) for visualizing the group to the user.

25. The device of claim 24, configured to visualize the group by listing the identifiers of one or more devices in the group.

26. The device of claim 25, configured to list said identifiers substantially on one identifier per row basis.

27. The device of claim 25, further configured to display supplementary information related to each device the identifier of which listed.

28. The device of claim 24, further comprising means (510) for gathering user feedback related to the visualization of said group in order to specify the second device.

29. The device of claim 21, further configured to specify the second device on the basis of available data linkage information.

30. The device of claim 21 that is a mobile terminal, a PDA (Personal Digital Assistant), or a computer.

31. A virtual device service entity comprising processing means (402) and memory means (406) for processing instructions and storing data, and data transfer means (408) for transferring data, characterized in that it is configured to receive information from a first device, said information targeted to at least a second device, to store the information in a first location associated with the first device, to store said information stored in the first location associated with the first device in a second location associated with the second device; and upon occurrence of a predetermined event to transmit the information in the second location to the second device.

32. The entity of claim 31, further configured to adapt the information to the capabilities of the second device prior to said transmitting.

33. The entity of claim 32, wherein adapting includes at least one of the following: conversion of data from a form to another, deletion of data, replacement of data with an indication thereof.

34. The entity of claim 31, configured to extract identification information of the targeted second device from the received information.

35. The entity of claim 31, configured to poll new or amended data from said first device.

36. The entity of claim 31, wherein said predetermined event is at least one of the following: expiration of a timer, receipt of a synchronization request, registration to the service by the second device, and registration to the network by the second device.

37. The entity of claim 31, configured to transmit said information to the second device conditionally by first noticing the second device about forthcoming information transmission and executing the transmission not until the second device has authorized it.

38. The entity of claim 31, configured to maintain a number of virtual devices related to a number of physical devices utilizing the virtual device service.

39. The entity of claim 38, further configured to store said information in the second location due to polling of a first virtual device, said first virtual device associated with the first location, performed by a second virtual device associated with the second location.

40. The entity of claim 31, configured to poll the first device for new or amended information (304).

41. The entity of claim 31, configured to determine said second location on the basis of available linkage information associated with said first device.

42. The entity of claim 31 that is substantially a computer or a plurality of computers.

43. A system comprising a virtual device service entity (401) and at least a first and a second device (501) capable of communicating with said virtual device service entity (401), characterized in that
said first device comprises means (508) for sending information to said virtual device service entity,
said virtual device service entity comprises means (408) for receiving the information sent by said first device,
said virtual device service entity comprises means (406) for storing the information in a first location associated with said first device,
said virtual device service entity comprises means (406) for storing the information in a second location associated with said second device to which the information is targeted,
said virtual device service entity comprises means (408) for sending the information to said second device upon occurrence of a predetermined event, and
said second device comprises means (508) for receiving data from said virtual device service entity.

44. The system of claim 43, wherein said virtual device service entity maintains a number of virtual devices related to a number of physical devices utilizing the virtual device service.

45. A computer program comprising code means to execute the method steps of claim 1 or 14.

46. A carrier medium carrying the computer executable program of claim 45.
